(19) United States
(12) Patent Application Publication
(10) Pub. No.: US 2005/0137295 A1
(43) Pub. Date: Jun. 23, 2005

(54) Bituminous compositions modified by non-blocking elastomers

(75) Inventors: Harriet J.S. Kendrick, Cypress, TX (US); Robert Q. Kluttz, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON Polymers U.S. LLC, Houston, TX (US)

(21) Appl. No.: 11/010,927

(22) Filed: Dec. 13, 2004

Related U.S. Application Data
(60) Provisional application No. 60/530,295, filed on Dec. 17, 2003.

(51) Int. Cl. C08L 1/00

(52) U.S. Cl. 524/59

(57) ABSTRACT

Bituminous compositions are provided comprising a mixture of linear or radial block copolymers and diblock copolymers. The mass ratio of linear or radial block copolymer to diblock copolymer is in the range of about 5/1 to about 1/5 such that the resulting thermoplastic block copolymer composition mixes readily with bitumen but does not block before mixing. The non-blocking block copolymer composition has a bulk density in the range from about 20 lb/ft³ to about 30 lb/ft³ and includes from about 0.25% to about 10% by weight of a dusting agent. A process for producing the bituminous composition comprising high temperature, low shear mixing is also provided. The bituminous compositions herein provided are useful as road paving and asphaltic adhesive materials.

### FIELD OF THE INVENTION

The present invention relates to polymer modified bituminous compositions. In particular, the invention relates to a composition comprising a block copolymer with sufficient diblock content to enable facile admixing with the bituminous component while possessing non-blocking character before admixing. The invention further relates to a process for producing bituminous compositions comprising said block copolymer.

### BACKGROUND OF THE INVENTION

Naturally occurring or petroleum derived bitumen is a useful material for many applications. However, bitumen by itself often cannot meet the performance requirements for applications such as paving, roofing felts and water-proofing membranes. Therefore, approaches have been developed whereby polymers are added to the bitumen to increase properties such as low temperature flexibility and high temperature softening point. Improvements in either the low temperature or high temperature properties result in an increased temperature range of practical use. In some polymer-modified bitumen compositions the polymer is especially effective and these property increases occur simultaneously. In addition to improvements in temperature range of use, improvements in fatigue resistance, thermal cracking and rutting resistance can be achieved. However, in order for this approach to be of utility the polymer must be of such a character to allow reasonable mixing during processing.

Of particular utility in the field of polymer-modified bituminous compositions are anionic mono-alkenyl arene—conjugated diene block copolymers. U.S. Pat. No. 4,129,541 teaches the use of radial styrene—butadiene block copolymers to improve the low temperature flexibility and stress crack resistance of bitumen for cold temperature coating applications. As taught in US Statutory Invention Registration H1580, a high degree of network formation is important for development of the advantageous physical properties of modified bitumen. This high degree of network formation is achieved by the presence of block copolymers having multiple mono-alkenyl arene blocks.

While high molecular weight and a high degree of network formation are desirable from the point of view of physical property development of polymer modified bitumen, these polymer characteristics generally lead to difficult admixing in bitumen. Incorporation of limited amounts of diblock, as taught in U.S. Pat. No. 5,854,335, leads to reduction in high temperature viscosity of polymer modified bitumen. This, in turn, leads to more rapid mixing involving less shear and/or lower processing temperatures. This low temperature, low shear, low time mixing is further advantageous in that degradation of the polymer is avoided. However, as taught in U.S. Pat. No. 5,420,203 the presence of weak polymers such as diblock polymer lead to an increased tendency of the polymer modifier to block or fuse together upon storage. This blocking or fusing of the polymer can render it useless. Furthermore, a blocking polymer which has fused is difficult and expensive to clear from storage vessels.

It is the object of the present invention to provide a block copolymer of a radial or linear structure comprising a determined amount of diblock copolymer such that rapid and easy admixing with bitumen is achieved while maintaining a non-blocking character in the block copolymer before admixing.

### SUMMARY OF THE INVENTION

This invention relates to a modified bituminous composition comprising:
a. from about 0.5 to about 25 parts by weight of a dusted, non-blocking block copolymer composition consisting essentially of a mixture of a linear block copolymer A or a radial block copolymer B and a diblock copolymer C wherein each block copolymer comprises at least one mono-alkenyl arene block and at least one conjugated diene block, the mass ratio of A or B to C ranges from about 5/1 to about 1/5, the bulk density is in the range from about 20 lb/ft³ to about 30 lb/ft³, and wherein the dusting agent is from about 0.25% to about 10% by weight of the dusted, non-blocking block copolymer; and
b. from about 99.5 to about 75 parts by weight of bitumen.

In another embodiment the present invention relates to a process for the preparation of a modified bituminous composition comprising:
a. adding from about 0.25% to about 10% by weight of a dusting agent onto a non-blocking block copolymer composition wherein the block copolymer composition consists essentially of a mixture of a linear block copolymer A or a radial block copolymer B and a diblock copolymer C wherein each block copolymer has at least one mono-alkenyl arene block and at least one conjugated diene block and wherein the mass ratio of A or B to C ranges from about 5/1 to about 1/5, and wherein the bulk density is in the range from about 20 lb/ft³ to about 30 lb/ft³;
b. heating bitumen to a temperature from about 325° F. to about 375° F.;
c. admixing from 0.5 to 25 parts by weight of the dusted non-blocking block copolymer composition; and
d. stirring using a low shear mixer for less than 4 hours.

In further embodiments, the present invention relates to road paving and asphaltic adhesive materials comprising the non-blocking block copolymer composition.

The polymer of the invention admixes readily in hot bitumen while maintaining a non-blocking character before admixing.

### DETAILED DESCRIPTION OF THE INVENTION

The non-blocking block copolymers of the present invention may generally be prepared using anionic polymerization. Of particular use and interest are block copolymers comprised of more than one glassy mono-alkenyl arene block and at least one rubbery conjugated diene block. When of sufficiently high molecular weight and low mono-alkenyl arene content, such block copolymers are rubbery thermoplastic materials of broad utility.

In general, when solution anionic techniques are used, copolymers of mono-alkenyl arenes and conjugated dienes are prepared by contacting the monomers to be polymerized simultaneously or sequentially with an anionic polymerization initiator such as group IA metals, their alkyls, amides, silanolates, naphthalides, biphenyls or anthracenyl derivatives. It is preferred to use an organo alkali metal (such as lithium, sodium or potassium) compound in a suitable solvent at a temperature within the range from about −150° C. to about 300° C., preferably at a temperature within the range from about 0° C. to about 100° C. Particularly effective anionic polymerization initiators are organo lithium compounds having the general formula:
RLiₙ
wherein R is an aliphatic, cycloaliphatic, aromatic or alkyl-substituted aromatic hydrocarbon moiety having from 1 to about 20 carbon atoms and n is an integer of 1 to 4.

Conjugated dienes which may be polymerized anionically include those conjugated dienes containing from about 4 to about 24 carbon atoms such as 1,3-butadiene, isoprene, piperylene, methylpentadiene, phenyl-butadiene, 3,4-dimethyl-1,3-hexadiene, 4,5-diethyl-1,3-octadiene and the like. Isoprene and butadiene are the preferred conjugated diene monomers for use in the present invention because of the superior rubbery character imparted to their polymerized products and their low cost and ready availability. Mono-alkenyl arenes which may be copolymerized include vinyl aryl compounds such as styrene, various alkyl-substituted styrenes, alkoxy-substituted styrenes, vinyl naphthalene, alkyl-substituted vinyl naphthalenes and the like. Styrene is the preferred mono-alkenyl arene for use in the present invention because of its advantageous glassy physical properties and compatibility with bituminous materials in its polymerized form as well as its low cost and ready availability.

The non-blocking copolymers used to modify the bituminous compositions of the present invention are mixtures of linear or radial block copolymers and a diblock copolymer. The block copolymer composition of the present invention comprising linear block copolymers contains a linear triblock copolymer represented by the formula S₁-D₁-S₂ or S₁-D₁-S₁ and a diblock copolymer represented by the formula S₃-D₂ wherein S₁, S₂ and S₃ represent mono-alkenyl arene blocks, D₁ and D₂ represent conjugated diene blocks. In the embodiments of the present invention the S₁, S₂ and S₃ blocks may have identical or different molecular weights within the range of 5,000 to 25,000 daltons. Similarly, D₁ and D₂ may have identical or different molecular weights within the range of 50,000 to 150,000 daltons. The mass of the linear triblock copolymer is m. The mass of the diblock copolymer is n. The ratio m/n of linear triblock copolymer to diblock copolymer ranges from about 5/1 to about 1/5. In a preferred embodiment the linear triblock copolymer comprises a majority or equal part of the block copolymer composition such that m/n ranges from about 5/1 to about 1/1. In a most preferred embodiment m/n ranges from about 4/1 to about 3/2.

The linear triblock component may be constructed by sequential polymerization or by synthesis of a diblock followed by coupling. In the sequential polymerization protocol, the mono-alkenyl arene monomer is dissolved in an appropriate organic solvent. The monomer is then contacted with the organo lithium initiating compound and polymerization of the first mono-alkenyl arene block, S₁, ensues. Polymerization is continued until the mono-alkenyl arene monomer is consumed, wholly or partially. The living polymer so constructed is then contacted with the conjugated diene monomer and polymerization of the D₁ block ensues. Polymerization is continued until the conjugated diene monomer is consumed, wholly or partially. This living polymer is then contacted with a second aliquot of mono-alkenyl arene monomer and polymerization of the second mono-alkenyl arene block, S₂, ensues. In this fashion, a linear triblock copolymer represented by the formula S₁-D₁-S₂ is synthesized. The living polymer is then terminated and the sequential triblock copolymer is recovered from solution as a solid powder, crumb or pellet.

In the coupling polymerization protocol to form a linear triblock copolymer, the S₁ block is polymerized as in the case of the linear sequential triblock. The living polymer is then contacted with the conjugated diene monomer to begin polymerization of block D₁. In a typical variation of this protocol, the amount of conjugated diene monomer added in this second step is sufficient to form a living block having exactly ½ the total expected molecular weight of the final D₁ block. At the end of polymerization of the D₁ block the living polymer is then contacted with a coupling agent. In this fashion, a coupled linear triblock copolymer represented by the formula S₁-D₁S₁ is synthesized. The polymer is terminated and recovered from solution.

Typical coupling agents suitable for construction of linear triblock copolymers have at least two functional sites. These coupling agents are selected from a wide variety of compounds which include polyepoxides, polyhalides, silicon halides, alkoxy silanes, alkyl-alkoxy-silanes, polyisocyanates, polyketones, polyanhydrides, polyaldehydes, polyesters, polyimines, and the like. Of particular use are dihalo alkanes, dialkenyl dialkoxy silanes, dialkyl-dihalo silanes, and diglycidyl aromatic epoxides resulting as the reaction product of epichlorohydrin and bisphenol compounds. Diepoxide alkanes such as diepoxy octane and cycloaliphatic diepoxides such as diepoxy cyclooctane and vinyl cyclohexene dioxide are also useful coupling agents for the synthesis of linear polymers. Examples of diglycidyl aromatic epoxides are EPON® 825, EPON 826, EPON 828 and EPON 862 manufactured by Resolution Performance Products. The preferred coupling agents for the synthesis of linear block copolymers are dibromoethane, EPON 825, EPON 826, EPON 828, EPON 862, dimethyl-dimethoxy silane, vinyl cyclohexene dioxide, and diethyl-diethoxy-silane.

In one preferred embodiment, the diblock component present with the linear triblock component results as the uncoupled fraction when the triblock is formed by coupling. In this embodiment, S₁ and S₃ will have identical molecular weight. Accordingly, the molecular weight of D₂ will be half of the molecular weight of D₁. The ratio of triblock to diblock, m/n, will be controlled by the stoichiometry of the coupling reaction and the coupling process conditions of temperature and time.

In another preferred embodiment, the diblock present with the linear triblock copolymer represented by the formula S₁-D₁-S₂ is formed by a reinitiation synthesis protocol. In this synthesis, the S₁ block is first polymerized. At completion of S₁ polymerization, the conjugated diene is added and polymerization of D₁ is begun. At some time during the polymerization of D₁ a second aliquot of initiator is added to being new living polymer chains. In this way a second conjugated diene block, D₂, is begun. After the conjugated diene polymerization is complete, mono-alkenyl arene monomer is added to begin polymerization of S₂ from the living end of D₁ and S₃ from the living end of D₂. In this embodiment S₂ and S₃ will have identical molecular weights. The molecular weight of S₁ may be the same as or different from that of S₂ and S₃. Likewise, D₁ and D₂ may be the same or different with regard to molecular weight. The ratio of triblock to diblock, m/n, may be controlled by the amount of the second aliquot of initiator is added as well as the time of addition.

The block copolymer composition of the present invention comprising radial polymers contains a radial block copolymer represented by the formula (S₁-D₁)ₚX and a diblock copolymer represented by the formula S₃-D₂ wherein S₁ and S₃ represent mono-alkenyl arene blocks, D₁ and D₂ represent conjugated diene blocks, and X represents the residue of a multifunctional coupling agent. In the embodiments of the present invention the S₁ and S₂ blocks may have identical or different molecular weights within the range of 5,000 to 25,000 daltons. The molecular weight of D₁ and D₂ may have identical or different molecular weights within the range of 10,000 to 150,000 daltons. The number of arms of the radial block copolymer is represented by p and ranges from 3 to 12. The mass of the radial block copolymer is q. The mass of the diblock copolymer is n. The ratio q/n of radial block copolymer to diblock copolymer ranges from about 5/1 to about 1/5. In a preferred embodiment the block copolymer comprises a majority or equal part of the block copolymer composition such that q/n ranges from about 5/1 to about 1/1. In a most preferred embodiment q/n ranges from about 4/1 to about 3/2.

Any of the multifunctional coupling agents known in the prior art to be useful in forming a radial polymer by contacting the same with a living polymer may be used in this invention. The coupling agent is selected from the general classes listed herein as useful also for linear polymers. However, the suitable coupling agents for construction of the radial polymers of this invention will contain three or more functional groups which will react with the living polymer. Particularly useful coupling agents for the construction of radial polymers of this invention include the silicon tetrahalides such as silicon tetrafluoride, silicon tetrachloride, silicon tetrabromide and the like, and bis(trihalo)silanes such as bis(trihalo)silylethane and hexahalodisilane where the halogen may be fluorine, chlorine, bromine, or iodine, alkoxysilanes such as trimethoxy silane, tetramethoxy silane, triethoxy silane, tetraethoxy silane, alkyl-alkoxy silanes such as methyl-trimethoxy silane and ethyl-triethoxy silane, diesters such as dialkyl adipate where the alkyl group may be a linear or branched hydrocarbon of 1 to 20 carbon units, and polyfunctional epoxide compounds.

A preferred range of the number of coupled arms of the radial block copolymer, p, is from 3 to 12. A more preferred range is from 3 to 6. The most preferred range is from 3 to 5.

In another preferred embodiment of the present invention the diblock present with the radial block copolymer results as the uncoupled fraction. In this embodiment, S₁ and S₂ will have identical molecular weights. Likewise, the molecular weights of D₁ and D₂ will be identical in this embodiment.

In another preferred embodiment of the present invention the block copolymer is made by mixing a linear and/or radial block copolymer with a diblock copolymer. This mixing can occur before addition to the bitumen component. Alternately, the linear and/or radial and diblock copolymers may be added separately to the bitumen component. In this embodiment S₁, S₂ and S₃ may each have different molecular weights. Similarly, D₁ and D₂ may have different molecular weights in this embodiment.

The block copolymers of this invention have a mono-alkenyl arene content of about 20 to about 35% so that they are more compatible with bitumen and so that they will provide flow resistance at reasonable molecular weight. The preferred mono-alkenyl arene content ranges from 23 to 34%.

The block copolymers of this invention have overall number average molecular weight greater than 150,000 so that they improve flow resistance at low use levels and less than 800,000 so that they are compatible and readily mixable with bitumen. In one preferred embodiment, the number average molecular weights of the mono-alkenyl arene blocks independently range from 5,000 to 25,000 daltons and the number average molecular weights of the conjugated diene blocks independently range from 10,000 to 150,000 daltons.

In a more preferred embodiment, the block copolymer is a mixture of a linear triblock copolymer and a diblock copolymer wherein the number average molecular weight of the mono-alkenyl arene blocks ranges from 12,000 to 20,000 daltons and the number average molecular weight of the conjugated diene blocks ranges from 25,000 to 90,000 daltons.

In another more preferred embodiment, the block copolymer is a mixture of a radial block copolymer and a diblock copolymer wherein the number average molecular weight of the mono-alkenyl arene blocks ranges from 17,000 to 25,000 and the number average molecular weight of the conjugated diene blocks before coupling ranges from 40,000 to 50,000.

The molecular weights of linear polymers or unassembled linear segments of polymers such as mono-, di-, triblock, etc., arms of radial polymers before coupling are conveniently measured by Gel Permeation Chromatography (GPC), where the GPC system has been appropriately calibrated. For anionically polymerized linear polymers, the polymer is essentially mono-disperse and the weight average molecular weight/number average molecular weight ratio approaches unity. For materials to be used in the columns of the GPC, styrene-divinyl benzene gels or silica gels are commonly used and are excellent materials. Tetrahydrofuran is an excellent solvent for polymers of the type described herein. A refractive index detector may be used.

The present invention works with both unhydrogenated and hydrogenated polymers. Hydrogenated ones are useful in certain circumstances. While unhydrogenated diene polymers have a number of outstanding technical advantages, one of their principal limitations lies in their sensitivity to oxidation. This can be minimized by hydrogenating the copolymers, especially in the diene blocks. The hydrogenation of these polymers and copolymers may be carried out by a variety of well established processes including hydrogenation in the presence of such catalysts as Raney Nickel, noble metals such as platinum, palladium and the like and soluble transition metal catalysts. Titanium biscyclopentadienyl catalysts may also be used. Suitable hydrogenation processes which can be used are ones wherein the diene-containing polymer or copolymer is dissolved in an inert hydrocarbon diluent such as cyclohexane and hydrogenated by reaction with hydrogen in the presence of a soluble hydrogenation catalyst. Such processes are disclosed in U.S. Pat. Nos. 3,113,986, 4,226,952 and Reissue 27,145, the disclosures of which are herein incorporated by reference. The polymers are hydrogenated in such a manner as to produce hydrogenated polymers having a residual unsaturation content in the polydiene block of less than about 20%, and preferably as close to zero percent as possible, of their original unsaturation content prior to hydrogenation.

The blocking character of the finished product is not to be confused with the block structure of the copolymer. Rather, the blocking is herein and commonly defined in the art as the fusing together of solid polymer pellets or crumb or ground polymer granules or powder. Upon storage a blocking polymer will fuse under its own weight. The problem of blocking can be especially pronounced when large volumes are held in storage vessels. In that case, high compressive forces are applied to polymer residing in the lower regions of the storage vessels. Blocking is also aggravated by elevated storage temperatures.

Block copolymers polymerized in solvent can be converted from solution to the solid state by a number of means. For the polymers of the present invention of moderate to high molecular weight, the most common method is steam coagulation yielding a finished product typically known as a crumb. Tresulting crumb may then be passed through a dewatering extruder and a pelletizer followed by drying yielding a finished product typically referred to as a porous pellet. The back pressure and throughput of the extruder are controlled to determine the bulk density of the finished product. In alternate finishing processes, the crumb may be melt processes into a strand which is subsequently chopped to yield a dense pellet, or the crumb or pellets may be ground to yield a powder. In usual manufacturing operations, the finished product has a bulk density from 10 lb/ft³ to 35 lb/ft³. In the preferred embodiment of this invention the bulk density of the product is in the range from about 20 lb/ft³ to about 30 lb/ft³. At bulk densities below about 20 lb/ft³ the finished product has a tendency to block and fuse under bulk storage conditions. At bulk densities greater than 30 lb/ft³ the finished product is deleteriously slow to disperse in hot bitumen. In the most preferred embodiment the bulk density is in the range from about 22 lb/ft³ to about 27 lb/ft³.

In the present invention blocking is mitigated by coating the finished product with a suitable dusting agent. Suitable dusting agents include talc, silica, calcium stearate, zinc stearate, magnesium carbonate and calcium carbonate. The dusting agent is a fine powder or a slurry of a fine powder, i.e. a powder of which the average particle size lies between 1 nm and 100 μm, preferably between 5 nm and 10 μm. In principle any such fine powder may be employed. It is known in the art that talc is available in a variety of forms such as calcined, surface-treated, ultra-fine grades and high aspect ratio grades. Examples of commercially available silica powders are AEROSIL R972 (average particle size about 16 nm), AEROSIL 200 (average particle size about 12 nm), SIPERNAT, DUROSIL and ULTRASIL. OMYACARB 5 (average particle size 6 μm) and MILLICARB (average particle size 3 μm) are examples of commercially available calcium carbonate powders (both available from Omya). AEROSIL, SIPERNAT, DUROSIL, ULTRASIL, OMYACARB, MILLICARB, MISTRON, CIMPACT, and TALCRON are trademarks. The most preferred dusting agents are fine grade powdered talc and silica.

A minimum amount of dusting agent is required in order to prevent blocking. Presence of a dusting agent of the surface of the finished product serves to reduce product tack and increase surface lubricity of the product. In this way, the tendency for product particles to adhere to each other to such a degree as blocking would occur is reduced. A maximum amount of dusting agent is determined according to economic and practical considerations. For instance, it is important to maintain a low “free dust” condition during manufacturing. Free dust is undesirable because of the hazards presented to workers and the potential for fouling of equipment. In the present invention, the dusting agent is used in an amount of from about 0.1 to 10% by weight basis the total weight of block copolymer and dusting agent. In one preferred embodiment of this invention, the finished product pellets are coated with a minimum of about 0.25% and a maximum of about 10% of a dusting agent. In a more preferred embodiment the pellets are coated with a minimum of about 0.40% and a maximum of about 5% of a dusting agent.

The bituminous component, also known as asphalt, present in the bituminous compositions according to the present invention may be a naturally occurring bitumen or derived from a mineral oil. Also petroleum pitches obtained by a cracking process and coal tar can be used as the bituminous component as well as blends of various bituminous materials. Examples of suitable components include distillation or “straight-run bitumens”, precipitation bitumens, e.g. propane bitumens, blown bitumens, e.g. catalytically blown bitumen or “Multiphalt”, and mixtures thereof. Other suitable bituminous components include mixtures of one or more of these bitumens with extenders (fluxes) such as petroleum extracts, e.g. aromatic extracts, distillates or residues, or with oils. Suitable bituminous components (either “straight-run bitumens” or “fluxed bitumens”) are those having a penetration of in the range of from 50 to 300 dmm (deci-millimeters) at 25° C. In applications where the flexibility, tackiness or adhesion of the product is of high importance, fluxed bitumen having penetrations in the range of greater than 300 dmm at 25° C. are of particular use. The polymers of the present invention can be useful in the broad range from rigid bitumen to semi-liquid bitumen.

The polymer modifier is suitably present in the bituminous composition in an amount in the range of from 0.5 to 25% by weight. The lower ranges of polymer content are particularly interesting for applications, such as paving, which require a change of the bitumen character from viscous to visco-elastic. This change in properties generally occurs with polymer contents ranging from about 0.5% to about 10%. At higher polymer contents ranging to about 25% substantial increases in flexibility and elastic strength can be achieved. This is particularly interesting for roofing felt, adhesive and water-proofing membrane applications.

The bituminous composition may also, optionally, contain other ingredients such as may be required for the end-use envisaged. Thus fillers may be included, for example talc, aggregate, calcium carbonate and carbon black, or other components including resins, oils, stabilizers, ground tire rubber, or flame retardants may be incorporated. The content of such fillers and other components may be in the range of from 0 to as much as 99% by weight. Of course, if advantageous, other polymer modifiers may also be included in the bituminous composition of the invention.

Hot mix asphalt concrete compositions according to the present invention are especially advantageous. Hot mix asphalt concrete compositions according to the present invention will normally contain from 80 parts to 99 parts by weight of aggregate and from 1 part to 20 parts of a bituminous composition. The bituminous composition is generally comprised of 90 to 99.5 parts by weight per 100 parts of the bituminous composition of a bitumen and from 0.5 parts to 10 parts by weight per 100 parts of the bituminous composition of the block copolymer composition discussed herein. If less than 0.5 parts of the block copolymer composition is used, then improved properties are not obtained and if more than 10 parts of the block copolymer composition is used, then the composition is too costly and high in viscosity.

The useful low temperature and high temperature properties of the polymer-bitumen compositions of the present invention also enables such compositions to be of significant benefit in uses where the compositions are exposed to varying weather conditions, such as use in roofing applications, for example as a component of roofing felt. The usefully low high-temperature viscosity not only means that the polymer-bitumen compositions can be more easily processed but also means that they enable a greater amount of filler to be incorporated before the maximum allowable processing viscosity is achieved, and thus leading to a cheaper product in those applications where fillers are commonly used. In roofing compositions designed for roll roofing membranes a composition of 85 to 92 parts bitumen and 8 to 20 parts block copolymer composition is preferred. As with hot mix asphalt concrete compositions other additives such as inorganic fillers, resins, oils, and stabilizers may be added.

The block copolymers of the present invention are also useful in asphaltic adhesive applications. Asphaltic adhesive applications comprise from 50 to 95 parts by weight of a bituminous composition and from 5 to 50 parts by weight filler (such as limestone, calcium carbonate, carbon black). Light, low viscosity bitumen is particularly useful in asphaltic adhesive applications. The asphaltic adhesives are useful in outdoor applications requiring resistance to moisture and generally have good flow and high tack with particularly good bonding to other bitumen based materials and to construction materials in general. The asphaltic adhesives are particularly useful for laminating adhesives and tab adhesives. For laminating or tab adhesives the bituminous composition comprises from 90 to 96 parts bitumen and 4 to 10 parts block copolymer composition.

Other applications in which the bituminous compositions of the present invention may be of use are sound deadening and vibration dampening applications, sealant or coating applications, and pipe coating and carpet backing.

The admixing of bitumen and polymer should be conducted in a manner to minimize structural degradation of the block copolymer product. Structural degradation is evidenced by polymer chain scission, polymer crosslinking or a combination of both effects. This in turn leads to degradation of the polymer modified bitumen physical properties.

Processes for blending styrenic block copolymers into bitumen are well known in the art. Mixing processes comprise two basic types: high shear and low shear. In both processes the polymer is typically admixed with the bitumen in a tank. In low shear mixing it is preferred to agitate the blend in the tank with a vertical augur or impeller mixer, but often a circulating pump or sidearm impeller provides sufficient agitation. In a low shear mixing process, the blend is agitated until the polymer dissolves and disperses in the bitumen.

In a high shear mixing process, the blend is passed through a digesting mill that reduces the size of the polymer particles. The size of the polymer particles is typically reduced by roughly an order of magnitude. This reduction in particle size and increase in surface area allows the polymer particles to dissolve and disperse more rapidly.

Both low and high shear mixing processes are used commercially. While high shear mixing has the advantage that it is faster, it requires expensive equipment and can lead to structural degradation of the polymer by its intense mechanical action. Low shear mixing is preferred when low cost processes are desired and/or preservation of the structural integrity of the polymer is important.

The mixing temperature must be sufficiently high to achieve practically low mixture viscosities, while staying below temperatures causing undesirable structural degradation of the block copolymer product. Useful mixing temperatures of the process of the present invention are temperatures less than about 400° F. and greater than about 250° F. In one preferred embodiment the mixing temperature is between 300° F. and 380° F. In a more preferred embodiment the mixing temperature is between about 325° F. and 375° F.

The length of time of mixing at elevated temperatures is also an important consideration when maintenance of the block copolymer product structural integrity is a concern. In the present invention, mixing times as long as 8 hours may be used when temperatures as low as 250° F. are employed. When temperatures about 400° F. are employed, the mixing times are less than 2 hours. When the mixing temperature is between 325° F. and 375° F. then the mixing time is between 2 hours and 4 hours. In the preferred embodiment the stirring of the heated bitumen/block copolymer mixture is conducted for less than 4 hours. In the most preferred embodiment the mixing time is less than 3 hours.

### EXAMPLES

A blocking test is used to determine the relative propensity of a palletized, crumb or granulated block copolymer product to resist agglomeration under well defined conditions of temperature and pressure. A metal tube with a length of six inches and an inside diameter of two inches is placed vertically on a horizontal metal plate. The tube is then filled with the block copolymer product to be tested to one half inch of the top. A metal cylinder three fourths of an inch in length and one and fifteen sixteenths inch in diameter is placed in the open mouth of the tube on top of the block copolymer product.

A weight is then placed on top of the metal cylinder and the entire apparatus is placed in a forced air convection oven at a fixed temperature for a fixed period of time for conditioning. The weight, temperature and time are chosen to simulate conditions that the product would experience in actual storage and shipping. Typical values of the applied weight are 100 g to 500 g. The oven temperature typically ranges from about 80° F. to about 130° F. The length of conditioning time ranges from about 1 day to about 1 month.

After the prescribed conditioning, the apparatus is removed from the oven and allowed to cool to ambient temperature. The weight and metal cylinder are then removed and the tube is carefully lifted from the plate. If the column of block copolymer product does not spontaneously collapse then metal plates weighing 50 grams each are placed sequentially on top of the column until it collapses or until 10 plates have been added.

The recorded results include the conditioning weight, time and temperature and the number of plates needed to break the column from 0 to 10. For example, a block copolymer product is judged to be non-blocking if noplates are required to dislodge the block copolymer product after conditioning at 100° F. for seven days under an applied weight of 100 g.

### Example 1

Experimental samples were prepared by solution blending two coupled, linear block copolymers with high and low coupling efficiencies respectively. Polymers A and B were synthesized in the conventional manner by polymerizing styrene until the styrene monomer is consumed then adding butadiene. In this way a living diblock copolymer is formed. After the butadiene monomer is consumed, a difunctional coupling agent is added to affect a coupling reaction between two living diblock copolymers. The amount, expressed as a percentage, of living diblock copolymer which reacts to form a coupled block copolymer is referred to as the coupling efficiency. Polymer A had a styrene block number average molecular weight of 16,000, a butadiene block number average molecular weight of 44,000 before coupling and a triblock to diblock ratio of 5.25/1. Polymer B had a styrene block number average molecular weight of 16,000, a butadiene block number average molecular weight of 44,000 before coupling and a triblock to diblock ratio of 1/3.55.

Experimental Sample 1 was prepared by dissolving three parts of Polymer A and one part of Polymer B in cyclohexane then coagulating the resulting blend by contacting with steam. Experimental Sample 1 had a styrene block number average molecular weight of 16,000, a butadiene block number average molecular weight of 44,000 before coupling and a triblock to diblock ratio of 2.28/1.

### Example 2

Experimental Sample 2 was prepared in the same manner as experimental Sample 1 except that the blend composition was 2 parts Polymer A and 2 parts Polymer B. Experimental Sample 2 had a styrene block number average molecular weight of 16,000, a butadiene block number average molecular weight of 44,000 before coupling and a triblock to diblock ratio of 1.13/1.

### Example 3

Experimental Sample 3 was prepared in the same manner as experimental Sample 1 except that the blend composition was 1 part Polymer A and 3 parts Polymer B. Experimental Sample 3 had a styrene block number average molecular weight of 16,000, a butadiene block number average molecular weight of 44,000 before coupling and a triblock to diblock ratio of 1/1.67.

TABLE I

| | Polymer A | Polymer B | Sample 1 | Sample 2 | Sample 3 |
|---|---|---|---|---|---|
| Styrene block Mn | 16,000 | 16,000 | 16,000 | 16,000 | 16,000 |
| Butadiene block Mn (before | 44,000 | 44,000 | 44,000 | 44,000 | 44,000 |
| coupling) | | | | | |
| Triblock to diblock ratio | 5.25/1 | 1/3.55 | 2.28/1 | 1.13/1 | 1/1.67 |

### Example 4

### Prophetic

The Samples 1,2, and 3 of Table I are dusted with 0.5% weight talc. They are then subjected to the blocking test. Less than 10 plates are required to dislodge the block copolymer product from the test chamber. This result demonstrates that block copolymers having a triblock to diblock ratio in the range of about 2.5/1 to about 1/1.75 are non-blocking.

### Example 5 (prophetic)

The Samples 1, 2, and 3 of Table I are dusted with talc. The dusted block copolymer products are then admixed with bitumen heated to 350° F. to make mixtures containing 3% block copolymer by weight. The mixing is done using a low shear impeller blade mixer over a 3 hour period. This example demonstrates the process of making a modified bitumen product using a non-blocking block copolymer composition.

1. A modified bituminous composition comprising:
a. from about 0.5 to about 25 parts by weight of a dusted, non-blocking block copolymer composition consisting essentially of a mixture of a linear block copolymer A or a radial block copolymer B and a diblock copolymer C wherein each block copolymer comprises at least one mono-alkenyl arene block and at least one conjugated diene block, the mass ratio of A or B to C ranges from about 5/1 to about 1/5, the bulk density is in the range from about 20 lb/ft³ to about 30 lb/ft³, and wherein the dusting agent is from about 0.25% to about 10% by weight of the dusted, non-blocking block copolymer; and
b. from about 99.5 to about 75 parts by weight of bitumen.

2. The modified bituminous composition of claim 1 wherein the non-blocking block copolymer composition consists essentially of the radial block copolymer B represented by the formula (S₁-D₁)ₚX and the diblock copolymer C represented by the formula S₃-D₂ wherein S₁ and S₃ are styrene blocks, D₁ and D₂ are conjugated diene blocks, X is a residue of a coupling agent, p ranges from 3 to 12, the radial block copolymer mass is q, the diblock copolymer mass is n, and the ratio q/n ranges from about 5/1 to about 1/5, the number average molecular weights of S₁ and S₃ independently range from 5,000 to 25,000, and the number average molecular weights of D₁ and D₂ independently range from 10,000 to 150,000.

3. The modified bituminous composition of claim 1 wherein the mono-alkenyl arene is styrene.

4. The modified bituminous composition of claim 1 wherein the conjugated diene is selected from the group consisting of isoprene and butadiene.

5. The modified bituminous composition of claim 1 wherein the mono-alkenyl arene content is from about 20 to about 35 percent by weight of the block copolymer composition.

6. The modified bituminous composition of claim 1 wherein the conjugated diene is butadiene.

7. The modified bituminous composition of claim 2 wherein the coupling agent is selected from the group consisting of silicon tetrahalides, alkoxy silanes, alkyl alkoxy silanes, diesters, and polyfunctional epoxides compounds.

8. The modified bituminous composition of claim 2 wherein the ratio q/n ranges from about 4/1 to about 3/2.

9. The modified bituminous composition of claim 2 wherein the number average molecular weights of the styrene blocks S₁ and S₃ range from 17,000 to 25,000, and the number average molecular weights of the conjugated diene blocks D₁ and D₂ range from 40,000 to 50,000.

10. The modified bituminous composition of claim 1 wherein the bulk density of the non-blocking block copolymer composition is in the range from about 22 lb/ft³ to about 27 lb/ft³.

11. The modified bituminous composition of claim 1 wherein the added dusting agent is from about 0.4% to about 5% by weight.

12. The modified bituminous composition of claim 1 wherein the added dusting agent is talc or silica.

13. The modified bituminous composition of claim 1 wherein the non-blocking block copolymer composition consists essentially of the the linear triblock copolymer A represented by the formula S₁-D₁—S₂ or S₁-D₁S₁, and the diblock copolymer C represented by the formula S₃-D₂ wherein S₁, S₂, and S₃ are styrene blocks, D₁ and D₂ are conjugated diene blocks, the linear triblock copolymer mass is m, the diblock copolymer mass is n, and the ratio m/n ranges from about 5/1 to about 1/5, the number average molecular weights of S₁, S₂ and S₃ independently range from 5,000 to 25,000, and the number average molecular weights of D₁ and D₂ independently range from 10,000 to 150,000.

14. The modified bituminous composition of claim 13 wherein the coupling agent is selected from the group consisting of diglycidyl aromatic epoxies, dialkyl-dialkoxy silanes, dialkyl-dihalo silanes, cylcloaliphatic diepoxides, and dihalo alkanes.

15. The modified bituminous composition of claim 13 wherein the ratio m/n ranges from about 4/1 to about 3/2.

16. The modified bituminous composition of claim 13 wherein the number average molecular weights of the styrene blocks S₁, S₂, and S₃ independently range from 12,000 to 20,000 and wherein the number average molecular weights of the conjugated diene blocks D₁ and D₂ independently range from 25,000 to 90,000.

17. A road paving material comprising from 1 to 20 parts of the modified bituminous composition of claim 1 and from 80 parts to 99 parts aggregate.

18. An asphaltic adhesive material comprising from 50 to 95 parts by weight of the modified bituminous composition of claim 1 and from 5 to 50 parts by weight of a filler.

19. A process for the preparation of a modified bituminous composition comprising:
a. adding from about 0.25% to about 10% by weight of a dusting agent onto a non-blocking block copolymer composition wherein the block copolymer composition consists essentially of a mixture of a linear block copolymer A or a radial block copolymer B and a diblock copolymer C wherein each block copolymer has at least one mono-alkenyl arene block and at least one conjugated diene block and wherein the mass ratio of A or B to C ranges from about 5/1 to about 1/5, and wherein the bulk density is in the range from about 20 lb/ft³ to about 30 lb/ft³;
b. heating bitumen to a temperature from about 325° F. to about 375° F.;
c. admixing from 0.5 to 25 parts by weight of the dusted non-blocking block copolymer composition; and
d. stirring using a low shear mixer for less than 4 hours.

20. The process of claim 19 wherein the block copolymer composition consists essentially of the linear triblock copolymer A represented by the formula S₁-D₁—S₂ or S₁-D₁—S₁ and the diblock copolymer C represented by the formula S₃-D₂ wherein S₁, S₂, and S₃ are styrene blocks, D₁ and D₂ are conjugated diene blocks, the linear triblock copolymer mass is m, the diblock copolymer mass is n, and the ratio m/n ranges from about 5/1 to about 1/5, the number average molecular weights of S₁, S₂ and S₃ independently range from 5,000 to 25,000, and the number average molecular weights of D₁ and D₂ independently range from 10,000 to 150,000.

21. The process of claim 19 wherein the block copolymer composition consists essentially of the the radial block copolymer B represented by the formula (S₁-D₁)ₚX and the diblock copolymer copolymer C represented by the formula S₂-D₂ wherein S₁ and S₂ are styrene blocks, D₁ and D₂ are conjugated diene blocks, X is a residue of a coupling agent, p ranges from 3 to 12, the radial block copolymer mass is q, the diblock copolymer mass is n, and the ratio q/n ranges from about 5/1 to about 1/5, the number average molecular weights of S₁ and S₂ independently range from 5,000 to 25,000, and the number average molecular weights of D₁ and D₂ independently range from 10,000 to 150,000.

22. The process of claim 19 wherein the mono-alkenyl arene is styrene and ranges from about 20 to about 35 percent by weight of the block copolymer.

23. The process of claim 19 wherein the conjugated diene is selected from the group consisting of isoprene and butadiene.

24. The process of claim 21 wherein the ratio q/n ranges from about 4/1 to about 3/2.

25. The process of claim 19 wherein the added dusting agent is talc.

26. The process of claim 19 wherein the bulk density of the non-blocking block copolymer composition is in the range from about 22 lb/ft³ to about 37 lb/ft³.
